(19) United States
(12) Patent Application Publication
(10) Pub. No.: US 2017/0242542 A1
(43) Pub. Date: Aug. 24, 2017

(54) Method, Touch Sensitive Processor and Electronic System for Reducing Interference to Liquid Crystal Touch Screen from Touch Driving Signal

(71) Applicant: EGALAX_EMPIA TECHNOLOGY INC., Taipei City (TW)

(72) Inventors: CHIN-FU CHANG, TAIPEI CITY (TW); SHANG-TAI YEH, TAIPEI CITY (TW); CHENG-HAN LEE, TAIPEI CITY (TW)

(21) Appl. No.: 15/437,609

(22) Filed: Feb. 21, 2017

Related U.S. Application Data
(60) Provisional application No. 62/297,395, filed on Feb. 19, 2016.

(30) Foreign Application Priority Data
Dec. 30, 2016 (TW) 105144056

(51) Int. Cl. G06F 3/041; G09G 3/36; G06F 3/044

(52) U.S. Cl. CPC G06F 3/0418; G06F 3/044; G09G 3/3648; G06F 2203/04112; G09G 2300/0426

(57) ABSTRACT

The present invention provides a method for reducing interference to liquid crystal touch screen from touch driving signal, wherein the liquid crystal touch screen comprises a display composed of multiple pixel horizontal axes, multiple parallel first electrodes and multiple parallel second electrodes, multiple intersections are formed by the first electrodes and the second electrodes, the method comprising: concurrently providing sine wave driving signal to at least one of the first electrodes; and sensing the sine wave driving signal via the multiple second electrodes, wherein the multiple pixel horizontal axes are refreshed sequentially during the time interval of providing sine wave driving signal.

### CROSS REFERENCE TO RELATED APPLICATIONS

This application claims priority to U.S. provisional patent application, 62/297,395, filed on Feb. 19, 2016, and Taiwan patent application, 105144056, filed on Dec. 30, 2016, the disclosures of which are incorporated herein by reference.

### BACKGROUND OF THE INVENTION

1. Field of the Invention

The present invention relates to touch screen, and more particularly, to reduce electromagnetic interference to touch screen.

2. Description of the Prior Art

Touch screens are one of the main input/output devices of modern consumer electronic apparatuses. A typical touch sensitive screen is made in a touch panel whose circuitry is disposed above the screen. There are also touch screens in forms such as in-cell form and on-cell form, both of which are applicable within the scope of the invention of this application. For example, the contents of U.S. patent application Ser. No. 14/081,018, filed on Nov. 15, 2013 by the Applicant, can be an exemplary reference for this application.

Every touch screen possesses display characteristics including refresh rate and display resolution. Refresh rate commonly refers to the frequency of refreshing the screen, and is usually expressed in terms of the unit of frame per second (FPS). Taking the standards for analog televisions by the National Television System Committee (NTSC) for example, a touch sensitive screen has a refresh rate of 59.94 Hz and a resolution of 440×480 (440 by 480). The standard video graphic array (VGA)'s resolutions include 640×480 (640 by 480) and 320×200 (320 by 200) pixels, and their refresh rates include 50, 60, 70 Hz, etc. The common high resolution specification 1080P has a resolution of 1920×1080 (1920 by 1080), and has refresh rates of 24, 25, 30, 60 Hz, etc.

In general, every pixel of a modern liquid crystal display (LCD) has a corresponding pixel electrode used to twist polarity of liquid crystal, thereby changing transmittance of the liquid crystal of the pixel. Therefore, the amount of light transmission of light-emitting diodes of different colors below the liquid crystal can be controlled, and it is used to further control the color of each pixel. Typically, screen display controller uses square waves to implement PWM (pulse width modulation). PWM could be used to control transparency of liquid crystal of each pixel. As mentioned by U.S. Pat. No. 8,421,828, polarity of liquid crystal layer is related to RMS (root-mean-square) of voltage applying to the liquid crystal layer. During human eye's visual persistent period, signal modulated by PWM could be applied to liquid crystal layer for controlling the polarity of the layer so as to control the transparency of the layer.

A resolution such as 640×480 represents that there are 640 pixels on each horizontal axis and 480 pixels on each vertical axis of the screen. To refresh or update a screen, usually pixels of the uppermost horizontal axis are refreshed first. From the left to the right side, and then from the uppermost to the lowest horizontal axis, until refreshing of all pixels of all the horizontal axes is finished, completing the refreshing of a frame. Under a display characteristic of a refresh rate of 60 Hz, refreshing of 60 frames in the screen must be finished in 1 second. Further, there may be a period during which the screen appears still, before refreshing the first pixel and after refreshing the last pixel of each horizontal axis, which period may be called a horizontal blank. And there may be a period during which the screen appears still when refreshing the screen with the next frame, which period may be called a vertical blank.

For example, the screen specification 1080P60 (with a refresh rate of 60 Hz) has vertical blank appearing every 16.667 ms or 1/60 second, and since there are 1080 horizontal axes, the screen specification has horizontal blank appearing every 15.4 us or 1/(60*1080) second.

As shown in FIG. 1, typical touch sensitive electrodes are usually laid out along horizontal and vertical axes of a touch sensitive screen 110. It may be assumed that a plurality of parallel touch sensitive electrodes stretching along the horizontal axis are referred to as first electrodes 121, and a plurality of parallel touch sensitive electrodes stretching along the vertical axis are referred to as second electrodes 122. These first and second electrodes are usually connected or coupled to a touch sensitive processor 130, which performs touch sensitive detections by mutual-capacitance and/or self-capacitance.

Due to limitations on the design and costs of making of a touch sensitive processor, the number of touch sensitive electrodes that can be connected to the touch sensitive processor is very limited, so the numbers of first electrodes and second electrodes are usually less than respective aspects of the resolution of the screen. Taking a touch sensitive screen size of about 50 inches for example, its horizontal axis length is about 1130 mm and vertical axis length is about 670 mm. If the spacing between two electrodes is set as 8 mm, the screen will contain about 83 first electrodes and 141 second electrodes. In case the specification of the touch sensitive screen is 1080P, horizontal axis length of each pixel is 0.59 mm, and vertical axis length of each pixel is 0.62 mm. In other words, each first electrode covers about 12 pixel horizontal axes.

FIG. 2 shows an enlarged view of a part of a touch screen. As shown in FIG. 2, the upper portion includes a circuit comprising horizontal first electrodes 121 and vertical second electrodes 122 laid out and interconnected in rhombus shape, and the lower portion includes a pixel array comprising individual pixels 210. Since the number of all pixels is very large, not all of the pixels of the pixel array are shown. In refreshing or updating a screen, the refreshing is performed by the unit of a pixel horizontal axis 220. In the embodiment shown in FIG. 2, it can be seen that each first electrode 121 covers 6 pixel horizontal axes 220, wherein pixel horizontal axis 221 is located between two first electrodes, and pixel horizontal axis 222 is covered by a first electrode.

It is common for a touch screen 110, touch sensitive processor 130 and display controller are operating independently. Touch sensitive processor 130 usually has no idea of the display characteristics of the touch screen 110 such as resolution and refresh rate. Moreover, touch sensitive processor 130 also has no information which the pixel horizontal axis of the touch screen 110 is updated by the display controller. Touch sensitive processor 130 may perform mutual capacitive detection by directing one first electrode 121 parallel to pixel horizontal axes to transmit multiple square waves as driving signal and directing all second electrodes 122 to receive sensing signal with regard to the driving signal. If coincidentally a pixel horizontal axis covered by the first electrode 121 is updated concurrently by the display controller, the polarity level of the pixel's liquid crystal would be severely affected since the driving signal is composed by square waves and the pixel update is also controlled by PWM signal such that the user of the touch screen may observe brightness abnormality around the first electrode 121. However, the detection period of the touch sensitive processor and the screen refresh are quite fast. The probability of observing brightness abnormality while mutual capacitive detection is performed is not high.

Touch sensitive processor 130 may perform full screen detection or self-capacitive detection. Under these two detection modes, touch sensitive processor 130 may direct all first electrodes 121 and/or all second electrodes 122 to transmit driving signal composed by multiple square waves. During this time period, no matter which one of pixel horizontal axis is refreshed, it would be affected by the touch driving signal and the consequent brightness abnormality would be observed by the user. Some users describe the abnormality appears like water winkles. In multiple human eye's visual persistent periods, the abnormalities corresponding to pixel horizontal axes gradually move from top to bottom of the touch screen or vice versa.

Hence, how to avoid the interference on LCD touch screen from the touch signal is a main problem the present invention wants to solve.

From the above it is clear that prior art still has shortcomings. In order to solve these problems, efforts have long been made in vain, while ordinary products and methods offering no appropriate structures and methods. Thus, there is a need in the industry for a novel technique that solves these problems.

### SUMMARY OF THE INVENTION

In the embodiment, the present invention provides a method for reducing interference to liquid crystal touch screen from touch driving signal, wherein the liquid crystal touch screen comprises a display composed of multiple pixel horizontal axes, multiple parallel first electrodes and multiple parallel second electrodes, multiple intersections are formed by the first electrodes and the second electrodes, the method comprising: concurrently providing sine wave driving signal to at least one of the first electrodes; and sensing the sine wave driving signal via the multiple second electrodes, wherein the multiple pixel horizontal axes are refreshed sequentially during the time interval of providing sine wave driving signal.

In one example, in order to perform a full-screen detection for detecting whether any external conductive object approximating or touching the liquid crystal touch screen, the step of concurrently providing sine wave driving signal to at least one of the first electrodes further comprises concurrently providing the sine wave driving signal to all of the first electrodes.

In one example, because the method can reduce interference to liquid crystal touch screen from touch driving signal, the multiple parallel first electrodes are parallel to the pixel horizontal axes. In one example, at least one of the pixel horizontal axes refreshed sequentially is covered by the first electrode.

Although first electrode is close to pixel electrodes which controls pixel horizontal axis refresh in the structure of “in-cell” liquid crystal display, the method can still reduce interference to liquid crystal touch screen from touch driving signal. In one example, the liquid crystal touch screen is structured as “in-cell” form. In another example, because the method can be also applicable to “on-cell” LCD, the liquid crystal touch screen is structured as “on-cell” form.

In one embodiment, the present invention provides a touch sensitive processor for reducing interference to liquid crystal touch screen from touch driving signal, wherein the liquid crystal touch screen comprises a display composed of multiple pixel horizontal axes, multiple parallel first electrodes and multiple parallel second electrodes, multiple intersections are formed by the first electrodes and the second electrodes, the touch sensitive processor comprising: a driving circuit for concurrently providing sine wave driving signal to at least one of the first electrodes; and a sensing circuit for sensing the sine wave driving signal by the multiple second electrodes, wherein the multiple pixel horizontal axes are refreshed sequentially by a display controller during the time interval of providing sine wave driving signal.

In one example, in order to perform a full-screen detection for detecting whether any external conductive object approximating or touching the liquid crystal touch screen, the step of providing sine wave driving signal by the driving circuit further comprises concurrently providing the sine wave driving signal to all of the first electrodes.

In one example, because the touch sensitive processor can reduce interference to liquid crystal touch screen from touch driving signal, the multiple parallel first electrodes are parallel to the pixel horizontal axes. In one example, at least one of the pixel horizontal axes refreshed sequentially is covered by the first electrode.

Although first electrode is close to pixel electrodes which controls pixel horizontal axis refresh in the structure of “in-cell” liquid crystal display, the touch sensitive processor can still reduce interference to liquid crystal touch screen from touch driving signal. In one example, the liquid crystal touch screen is structured as “in-cell” form. In another example, because the touch sensitive processor can be also applicable to “on-cell” LCD, the liquid crystal touch screen is structured as “on-cell” form.

In one embodiment, the present invention provides an electronic system for reducing interference to liquid crystal touch screen from touch driving signal, the electronic system comprising: a liquid crystal touch screen; a display controller; and a touch sensitive processor. The liquid crystal touch screen comprises a display composed of multiple pixel horizontal axes, multiple parallel first electrodes and multiple parallel second electrodes; multiple intersections are formed by the first electrodes and the second electrodes. The display controller is configured for refreshing the pixel horizontal axes sequentially. The touch sensitive processor comprising: a driving circuit for concurrently providing sine wave driving signal to at least one of the first electrodes; and a sensing circuit for sensing the sine wave driving signal by the multiple second electrodes, wherein the multiple pixel horizontal axes are refreshed sequentially by the display controller during the time interval of providing sine wave driving signal.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 is a diagram of a traditional touch sensitive electronic system.

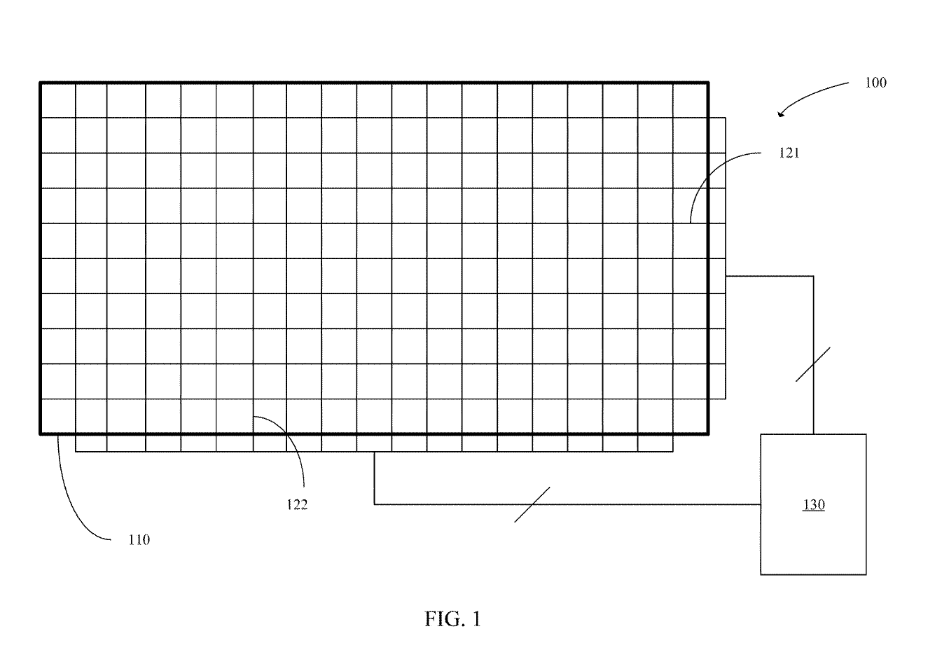

FIG. 2 depicts an enlarged view of a touch screen shown in the FIG. 1.

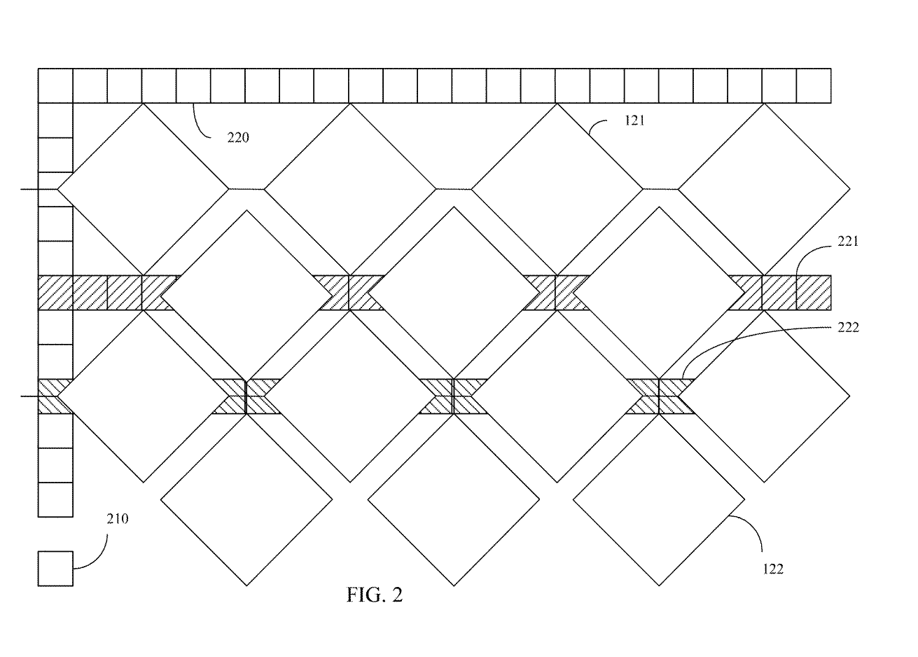

FIG. 3 illustrates an ideal wave of a touch driving signal in accordance with an embodiment of the present invention.

FIG. 4 shows a flowchart diagram with regard to a method for reducing interference to touch screen from touch driving signal.

FIG. 5 depicts an electronic system for reducing interference to touch screen from touch driving signal in accordance with an embodiment of the present invention.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

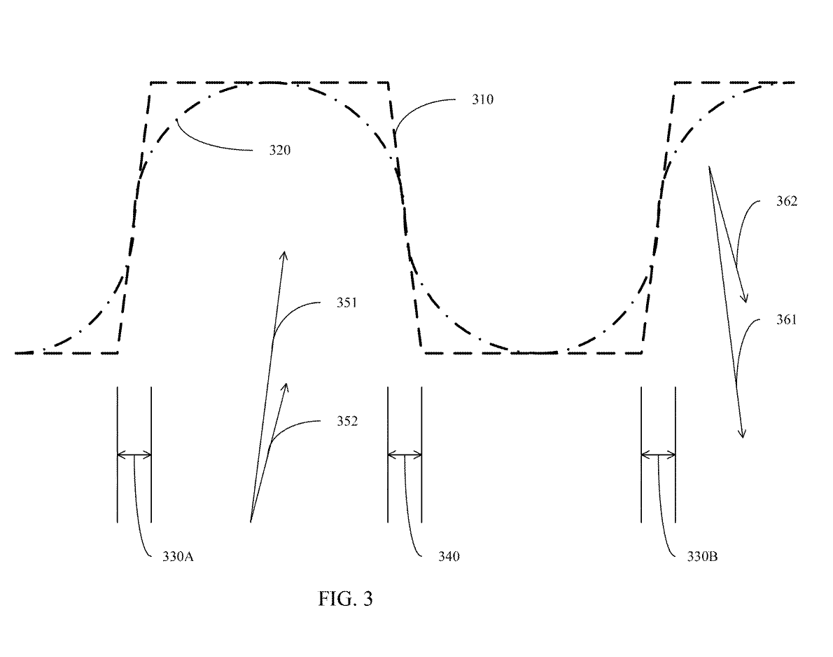

Please refer to FIG. 3, which illustrates an ideal wave of a touch driving signal in accordance with an embodiment of the present invention. Two waves of driving signals are shown in the FIG. 3. One is traditional square wave 310, the other is sine wave 320 in accordance with the present embodiment. These two waves 310 and 320 have same amplitude and period. Two rising edges 330A and 330B are shown in the FIG. 3. Only one falling edge 340 is shown in the FIG. 3. In practical, generated wave always has rising time and falling time for rising edge and falling edge, respectively. The square wave 310 shown in the FIG. 3 take some time to raise and to lower voltage during the rising edge and the falling edge, respectively.

At the raising edges 330A and 330B, the voltage change rate of the square wave 310 could be represented by a vector 351, and the voltage change rate of the sine wave 320 could be represented by a vector 352. It is well understood that the rising angle of the vector 351 is double to the rising angle of the vector 352. At the falling edge 340, the voltage change rate of the square wave 310 could be represented by a vector 361, and the voltage change rate of the sine wave 320 could be represented by a vector 362. It is easily observed that the falling angle of the vector 361 is double to the falling angle of the vector 362.

It is easily understood that during the raising edges 330A and 330B, the interference caused by square wave 310 to the pixel update is as strong as twice the interference caused by sine wave 320. Similarly, during the falling edge 340, the interference caused by square wave 310 to the pixel update is as strong as twice the interference caused by sine wave 320. Although the voltage change rates of sine wave 320 between the raising edge and the falling edge are not zero, their vectors are positioned between the vectors 352 and 362. Hence, the interference is quite limited. Even it has gradual influence, and it does not draw user's immediate attention comparing to the instantaneous inferences with regard to the vectors 351 and 361.

Consequently, one implementation of the present invention is to have the touch sensitive processor to change the driving signals transmitted by the touch electrodes from square wave to sine wave in order to reduce instantaneous interference to pixel updates so as to alleviate brightness abnormalities phenomena caused by the interference. The implementation could be applicable to a case in which only one touch electrode emitting driving signal at one time, for example, mutual capacitive detection. It could be applicable to another case in which multiple touch electrodes emitting driving signals concurrently, for example, one full-screen detection is performed as following: all first electrodes 121 are provided with driving signals concurrently and all second electrodes 122 are responsible for sensing driving signals at the same time. This implementation could be also applicable to self-capacitive detection which is performed as following: concurrently providing driving signals to all first electrodes 121 and concurrently sensing by all first electrodes 121 to measure a vertical position where an external conductive object locates; and concurrently providing driving signals to all second electrodes 122 and concurrently sensing by all second electrodes 122 to measure a horizontal position where the external conductive object locates. All of the driving signals mentioned in this paragraph could comprise the sine waves disclosed by the present invention.

Besides the implementation which changes driving signals from square wave to sine wave, when performing full-screen detection, the timings for providing driving signals to different first electrodes could be adjusted differently, such that the pixel horizontal axes covered by one first electrode 121 would not be interfered concurrently by neighboring first electrodes at the same time. In other words, the touch sensitive processor provides square wave driving signal to one electrode at a first timing and provides square wave driving signal to an adjacent electrode parallel to the electrode. And the second timing is later than the first timing. In one example, the interval between the first timing and the second timing is shorter than one period of the square wave driving signal.

If one period of the square wave driving signal is too short to provide square wave driving signals to all parallel electrodes in sequence, the multiple parallel electrodes could be divided into groups. For each group, the sum of timing intervals for providing square wave driving signals to the electrodes of this group could be arranged being shorter than one period of the square wave driving signal. In an example, there are 20 electrodes divided into five groups. There are four electrodes in each group. For each group, the interval between timings to provide square wave driving signal is one-fifth period of square wave. At one moment, square wave driving signals are provided to a certain electrode of each group. Since the electrodes which are provided with square wave driving signals locate distantly, the pixel horizontal axes covered by one electrode would not be affected by square wave driving signals emitted by other electrodes neighboring to the electrode at the same moment.

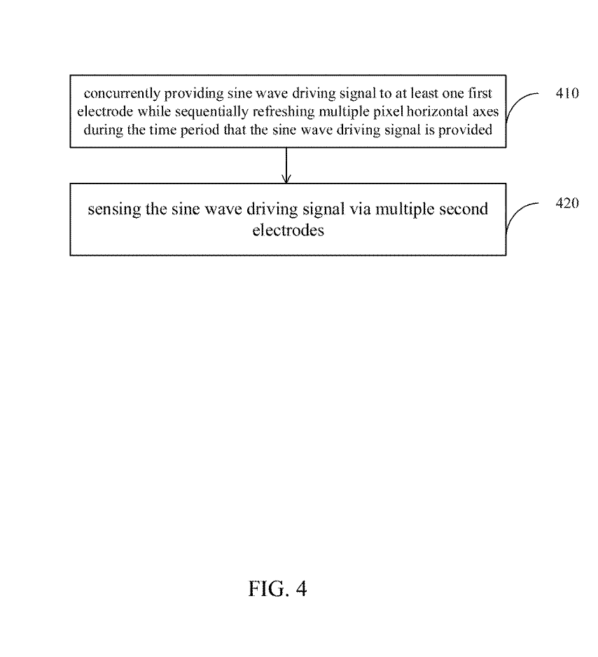

Please refer to FIG. 4, which shows a flowchart diagram with regard to a method for reducing interference to touch screen from touch driving signal. The method comprises two steps. Step 410: a touch sensitive processor concurrently provides sine wave driving signal to at least one first electrode while a display controller sequentially refresh multiple pixel horizontal axes during the time period that sine wave driving signal is provided. At least one of the multiple pixel horizontal axes is covered by the first electrode. Step 420: the touch sensitive processor senses the sine wave driving signal via multiple second electrodes. The steps 410 and 420 could be performed at the same time. Or in another example, the step 410 is followed by the step 420. Part of the performing time intervals of these two steps is overlapped.

In the embodiment, the present invention provides a method for reducing interference to liquid crystal touch screen from touch driving signal, wherein the liquid crystal touch screen comprises a display composed of multiple pixel horizontal axes, multiple parallel first electrodes and multiple parallel second electrodes, multiple intersections are formed by the first electrodes and the second electrodes, the method comprising: concurrently providing sine wave driving signal to at least one of the first electrodes; and sensing the sine wave driving signal via the multiple second electrodes, wherein the multiple pixel horizontal axes are refreshed sequentially during the time interval of providing sine wave driving signal.

In one example, in order to perform a full-screen detection for detecting whether any external conductive object approximating or touching the liquid crystal touch screen, the step of concurrently providing sine wave driving signal to at least one of the first electrodes further comprises concurrently providing the sine wave driving signal to all of the first electrodes.

In one example, because the method can reduce interference to liquid crystal touch screen from touch driving signal, the multiple parallel first electrodes are parallel to the pixel horizontal axes. In one example, at least one of the pixel horizontal axes refreshed sequentially is covered by the first electrode.

Although first electrode is close to pixel electrodes which controls pixel horizontal axis refresh in the structure of “in-cell” liquid crystal display, the method can still reduce interference to liquid crystal touch screen from touch driving signal. In one example, the liquid crystal touch screen is structured as “in-cell” form. In another example, because the method can be also applicable to “on-cell” LCD, the liquid crystal touch screen is structured as “on-cell” form.

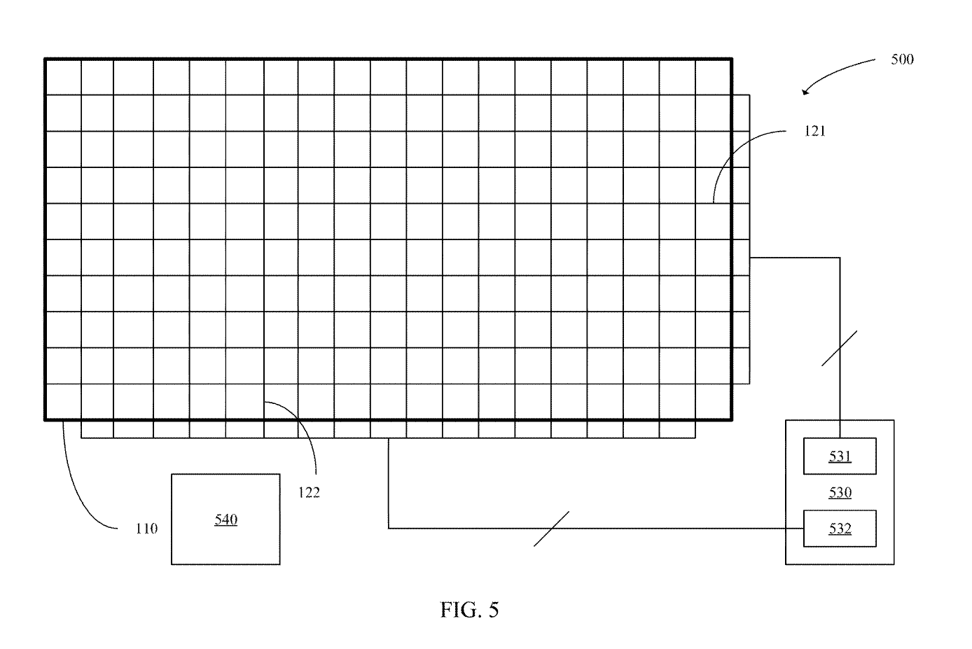

Please refer to FIG. 5 which depicts an electronic system 500 for reducing interference to touch screen from touch driving signal in accordance with an embodiment of the present invention. The electronic system 500 comprises a liquid crystal touch screen 510; a display controller 540; and a touch sensitive processor 530. The liquid crystal touch screen 110 comprises a display composed of multiple pixel horizontal axes, multiple parallel first electrodes 121 and multiple parallel second electrodes 122, multiple intersections are formed by the first electrodes 121 and the second electrodes 122. The display controller 540 is configured for refreshing the multiple pixel horizontal axes sequentially. The touch sensitive processor 530 comprises a driving circuit 531 for concurrently providing sine wave driving signal to at least one of the first electrodes 121; and a sensing circuit 532 for sensing the sine wave driving signal by the multiple second electrodes 122, wherein the multiple pixel horizontal axes are refreshed sequentially by the display controller 540 during the time interval of providing sine wave driving signal.

In one embodiment, the present invention provides a touch sensitive processor for reducing interference to liquid crystal touch screen from touch driving signal, wherein the liquid crystal touch screen comprises a display composed of multiple pixel horizontal axes, multiple parallel first electrodes and multiple parallel second electrodes, multiple intersections are formed by the first electrodes and the second electrodes, the touch sensitive processor comprising: a driving circuit for concurrently providing sine wave driving signal to at least one of the first electrodes; and a sensing circuit for sensing the sine wave driving signal by the multiple second electrodes, wherein the multiple pixel horizontal axes are refreshed sequentially by a display controller during the time interval of providing sine wave driving signal.

In one example, in order to perform a full-screen detection for detecting whether any external conductive object approximating or touching the liquid crystal touch screen, the step of providing sine wave driving signal by the driving circuit further comprises concurrently providing the sine wave driving signal to all of the first electrodes.

In one example, because the touch sensitive processor can reduce interference to liquid crystal touch screen from touch driving signal, the multiple parallel first electrodes are parallel to the pixel horizontal axes. In one example, at least one of the pixel horizontal axes refreshed sequentially is covered by the first electrode.

Although first electrode is close to pixel electrodes which controls pixel horizontal axis refresh in the structure of “in-cell” liquid crystal display, the touch sensitive processor can still reduce interference to liquid crystal touch screen from touch driving signal. In one example, the liquid crystal touch screen is structured as “in-cell” form. In another example, because the touch sensitive processor can be also applicable to “on-cell” LCD, the liquid crystal touch screen is structured as “on-cell” form.

In one embodiment, the present invention provides an electronic system for reducing interference to liquid crystal touch screen from touch driving signal, the electronic system comprising: a liquid crystal touch screen; a display controller; and a touch sensitive processor. The liquid crystal touch screen comprises a display composed of multiple pixel horizontal axes, multiple parallel first electrodes and multiple parallel second electrodes; multiple intersections are formed by the first electrodes and the second electrodes. The display controller is configured for refreshing the pixel horizontal axes sequentially. The touch sensitive processor comprising: a driving circuit for concurrently providing sine wave driving signal to at least one of the first electrodes; and a sensing circuit for sensing the sine wave driving signal by the multiple second electrodes, wherein the multiple pixel horizontal axes are refreshed sequentially by the display controller during the time interval of providing sine wave driving signal.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A method for reducing interference to liquid crystal touch screen from touch driving signal, wherein the liquid crystal touch screen comprises a display composed of multiple pixel horizontal axes, multiple parallel first electrodes and multiple parallel second electrodes, multiple intersections are formed by the first electrodes and the second electrodes, the method comprising:
concurrently providing sine wave driving signal to at least one of the first electrodes; and
sensing the sine wave driving signal via the multiple second electrodes,
wherein the multiple pixel horizontal axes are refreshed sequentially during the time interval of providing sine wave driving signal.

2. The method of claim 1, wherein the step of concurrently providing sine wave driving signal to at least one of the first electrodes further comprises concurrently providing the sine wave driving signal to all of the first electrodes.

3. The method of claim 1, wherein the multiple parallel first electrodes are parallel to the pixel horizontal axes.

4. The method of claim 3, wherein at least one of the pixel horizontal axes refreshed sequentially is covered by the first electrode.

5. The method of claim 1, wherein the liquid crystal touch screen is structured as “in-cell” form.

6. A touch sensitive processor for reducing interference to liquid crystal touch screen from touch driving signal, wherein the liquid crystal touch screen comprises a display composed of multiple pixel horizontal axes, multiple parallel first electrodes and multiple parallel second electrodes, multiple intersections are formed by the first electrodes and the second electrodes, the touch sensitive processor comprising:
a driving circuit for concurrently providing sine wave driving signal to at least one of the first electrodes; and
a sensing circuit for sensing the sine wave driving signal by the multiple second electrodes,
wherein the multiple pixel horizontal axes are refreshed sequentially by a display controller during the time interval of providing sine wave driving signal.

7. The touch sensitive processor of claim 6, wherein the step of concurrently providing by the driving circuit further comprises concurrently providing sine wave driving signal to all of the first electrodes.

8. The touch sensitive processor of claim 6, wherein the multiple parallel first electrodes are parallel to the pixel horizontal axes.

9. The touch sensitive processor of claim 8, wherein at least one of the pixel horizontal axes refreshed sequentially is covered by the first electrode.

10. The touch sensitive processor of claim 6, wherein the liquid crystal touch screen is structured as “in-cell” form.

11. An electronic system for reducing interference to liquid crystal touch screen from touch driving signal, comprising:
a liquid crystal touch screen comprises:
a display composed of multiple pixel horizontal axes;
multiple parallel first electrodes; and
multiple parallel second electrodes,
wherein multiple intersections are formed by the first electrodes and the second electrodes;
a display controller for sequentially refreshing the pixel horizontal axes; and
a touch sensitive processor comprises:
a driving circuit for concurrently providing sine wave driving signal to at least one of the first electrodes; and
a sensing circuit for sensing the sine wave driving signal by the multiple second electrodes,
wherein the multiple pixel horizontal axes are refreshed sequentially by the display controller during the time interval of providing sine wave driving signal.

12. The electronic system of claim 11, wherein the step of concurrently providing by the driving circuit further comprises concurrently providing sine wave driving signal to all of the first electrodes.

13. The electronic system of claim 11, wherein the multiple parallel first electrodes are parallel to the pixel horizontal axes.

14. The electronic system of claim 13, wherein at least one of the pixel horizontal axes refreshed sequentially is covered by the first electrode.

15. The electronic system of claim 11, wherein the liquid crystal touch screen is structured as “in-cell” form.
